(19) United States
(12) Patent Application Publication
(10) Pub. No.: US 2015/0281643 A1
(43) Pub. Date: Oct. 1, 2015

(54) VIDEO REPLY SYSTEM AND METHOD

(71) Applicant: Barry Calvagna, Commack, NY (US)

(72) Inventor: Barry Calvagna, Commack, NY (US)

(73) Assignees: John Mincone, Melville, NY (US); Jeffrey Scott Melcher, Boca Raton, FL (US)

(21) Appl. No.: 14/644,242

(22) Filed: Mar. 11, 2015

Related U.S. Application Data
(60) Provisional application No. 61/973,103, filed on Mar. 31, 2014.
(60) Provisional application No. 61/973,645, filed on Apr. 1, 2014.
(60) Provisional application No. 62/074,202, filed on Nov. 3, 2014.

(51) Int. Cl. H04N 7/15

(52) U.S. Cl. CPC H04N 7/15

(57) ABSTRACT

Provided are a video reply system and method using a smartphone.

### FIELD OF THE INVENTION

The invention relates to video reply system and method.

### BACKGROUND OF THE INVENTION

There is no known video reply application, only video posting with text reply. In present systems, when a video is posted, users provide written responses, by texting, email, or blogs.

### SUMMARY OF THE INVENTION

An objective of the invention is to provide an immediate recorded video response instead of a text reply. The replies are short, preferably less than 10 minutes, more preferably 5 minutes or less, and most preferably 3 minutes or less.

The invention can utilize a computer or hand-held user interface device.

Traditionally, communication such as texting is impersonal and boring. The present video reply system brings back a way to communicate in real time or delayed time with a video of choice. Any video could be used to initiate a response. After a user makes a video and saves it on a user interface device, they could show that video and receive a video reply from other users. The users can reply to the video and video replies as desired.

The objectives of the invention can be obtained by a video reply or video texting method comprising:
making a first video and voice recording by a first user by a first user interface device having a video and audio recorder;
posting the first video to a website, along with an associated title and tag; making a second video and voice in reply to the first video by a second user by a second user interface device having a video and audio recorder; and
posting the second video to the website, along with an associated title and tag.

The objectives of the invention can also be obtained by a video reply system comprising:
a cloud-based server connected to a network, the cloud-based server being in communication with or comprising at least one non-volatile memory, a database stored in the non-volatile memory, the database comprising video and voice recordings and video and voice reply recordings;
a first user interface device configured to make a video and voice recording, the first user interface being connected to the internet and in communication with the cloud-based server;
a second user interface device configured to make a video and voice recording, the second user interface being connected to the internet and in communication with the cloud-based server;
a video software module for uploading a first video and voice recording by a first user, storing the video and voice recording in the database along with a title, user name, and hashtag to identify the video and voice recording, for uploading a second video and voice recording by a second user in reply to the first video and voice recording, along with a title, user name, and hashtag, for displaying the first and second video and voice recordings, and for notifying the first use that the second video and voice recording was posted in response to the first video and voice recording; and a registration software module for registering users personal information including name, location, and friends and storing the personal information in the database.

### BRIEF DESCRIPTION OF THE DRAWINGS

FIG. 1 illustrates an exemplary video reply system.

FIG. 2 illustrates a Screen flow chart of the www.irantnow.com example.

FIG. 3 illustrates a Category search screen 10.

FIG. 4 illustrates a screen 11 view dating videos and screen 12 search dating type.

FIG. 5 illustrates a screen 13 browse free video posts and a screen 22 invite friends from Twitter.

FIG. 6 illustrates a screen 23 invite friends from Facebook and screen 24 invite friends from iRant.

FIG. 7 illustrates Profile landing screens 6 and 7.

FIG. 8 illustrates a Mobile app sign-up screen 3.

FIG. 9 illustrates iRant professional landing screens 8 and 9.

FIG. 10 illustrates a User profile following screen 58 and friends landing screen 59.

FIG. 11 illustrates a Live stream screen 18 and a friend rants video landing screen 19.

FIG. 12 illustrates a Most viewed videos screen 20 and iRant pro video landing screen 21.

FIG. 13 illustrates a Find friends landing screen 25 and drop down screens 29-31.

FIG. 14 illustrates an Edit user profile screen 28.

FIG. 15 illustrates Home landing screens 14 and 15.

FIG. 16 illustrates Welcome message screen 5.

FIG. 17 illustrates Notifications screen 5 and friend request landing screen 55.

FIG. 18 illustrates Camera screen 51 and video post category screen 52.

FIG. 19 illustrates User followers screen 57 and following screens 58.

FIG. 20 illustrates Users friends profile list screen 59.

FIG. 21 illustrates iRant professional video category upload screens 69 and 70.

FIG. 22 illustrates iRant professional video category upload screens 67 and 68.

FIG. 23 illustrates iRant professional video category upload screens 65 and 66.

FIG. 24 illustrates iRant professional video category upload screens 62 and 63.

FIG. 25 illustrates an Add a comment screen 43 and drop down screens 44-46.

FIG. 26 illustrates Live steam video landing screen 48 and drop down screen 50.

FIG. 27 illustrates Post comment screen 36 and share to Facebook, Twitter, Email and SMS landing screen 47.

FIG. 28 illustrates iRant professional video posting criteria screens 60 and 61.

FIG. 29 illustrates Splash screen 1, log in screen 2, and drop down screens 71 and 72.

FIG. 30 illustrates Log in with Facebook screen 74 or Log in with Twitter screen 73.

FIG. 31 illustrates Log in with iRant landing screen 4.

FIG. 32 illustrates Free video posting upload criteria screen 49.

FIG. 33 illustrates iRant pro payment due alert screen 64.

FIG. 34 illustrates Rant back video landing screen 34, drop down screen 35, and main user profile landing screen 37.

FIG. 35 illustrates Go to Facebook tab 32 and App store tab 33.

FIG. 36 illustrates User profile bio screen 53.

FIG. 37 illustrates Rant back titling screen 40, live stream video screen 41 and drop Down screen 42.

FIG. 38 illustrates User profile bio screen 38 and video camera recording screen 39.

FIG. 39 illustrates Email invite landing screen 26 and invite from email screen 27.

FIG. 40 illustrates My profile or user profile screen 54.

FIG. 41 illustrates Updated home landing screen 71.

FIG. 42 illustrates Industry dedicated channel screen 72.

FIG. 43 illustrates All Industry channels screen 73.

FIG. 44 illustrates Updated log-in screen 74.

FIG. 45 illustrates New audio upload screen 75.

FIG. 46 illustrates a Rant back video landing screen in a user profile

### DETAILED DESCRIPTION OF THE INVENTION

In the following description, for purposes of explanation and not limitation, specific details are set forth, such as particular networks, communication systems, computers, terminals, devices, components, techniques, storage devices, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, computers, digital devices, storage devices, components, techniques, data and network protocols, software products and systems, development interfaces, operating systems, and hardware are omitted so as not to obscure the description of the present invention.

The invention will now be explained with reference to the attached non-limiting Figs. The operations described in Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

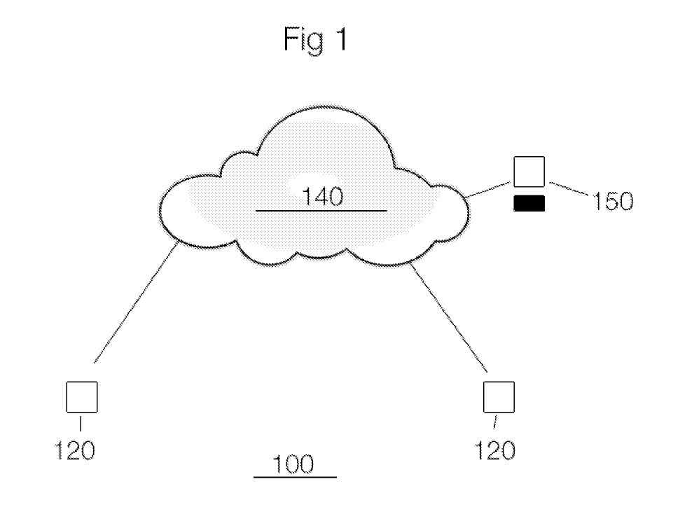

FIG. 1 describes a video reply system 100. The video reply system 100 comprises a plurality of user interface devices 120 and a main server 150 interconnected via a communication network 140. Various networks 140 may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications, such as by the network 140. Some suitable communications protocols may include TCP/IP, UDP, OSI, Ethernet, WAP, IEEE 802.11, Bluetooth, Zigbee, IrDa or any other desired protocol. Furthermore, components of the system may communicate through a combination of wired or wireless paths.

The video reply system 100 can be accessed via any user interface device 120 that is capable of connecting to the main server 150. The user interface device 120 comprises a display, and preferably a touch screen display, a video camera and a microphone for inputting sound. An exemplary user interface device 120 contains a web browser or similar program, allowing in some embodiments for a secure SSL connection, and able to display HTML and CSS. This includes user interface devices 120 such as tablets, iPads, Mac OS computers, Windows computers, e-readers, and mobile user devices such as the iPhone, Android, and Windows Phone. Preferably, the user interface device 120 is a tablet or phone. The user interface devices 120 can connect to the server 150 via the internet and/or wirelessly, such as through a mobile telephone network 140, and/or any other suitable medium. User interface devices 120 are able to communicate to the main server 150 so that content can be started on one user interface device 120 and later continued on a separate user interface device 120. The user interface device 120 preferably includes an I/O interface that allows a user to interact with the video reply system 100. The I/O interface may include any hardware, software, or combination of hardware and software.

The CPU of the user interface device 120 can be implemented as a conventional microprocessor, application specific integrated circuit (ASIC), digital signal processor (DSP), programmable gate array (PGA), or the like. The CPU executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The memory may include random access memory (RAM), ready-only memory (ROM), programmable memory, flash memory, and the like. The memory, include application programs, OS, application data etc. The exemplary computing device 120 also includes a network module connected to an antenna to communicate with rest of the video reply system 100.

The main server 150 described herein can include one or more computer systems directly connected to one another and/or connected over the network 140. Each computer system includes a processor, non-volatile memory, user input and user output mechanisms, a network interface, and executable program code (software) comprising computer executable instructions stored in non-transitory tangible memory that executes to control the operation of the main server 150. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The main server 150 can run any desired operating system, such as Windows, Mac OS X, Solaris or any other server based operating systems. Other embodiments can include different functional components. In addition, the present invention is not limited to a particular environment or main server 150 configuration. Preferably, the main server 150 is a cloud based computer system.

The main server 150 includes a web server and the query processing unit. The web server receives the user requests and sends it to the query processing unit. The query processing unit processes the request and responds back to the user interface device 120 via the web server. The query processing unit fetches data from the database server if additional information is needed for processing the request. The database is stored in the non-volatile memory. The term “database” includes a single database and a plurality of separate databases. The main server 150 can comprise the non-volatile memory or the main server 150 can be in communication with the non-volatile memory storing the database. The database can be stored at different locations.

Software program modules and data stored in the non-volatile memory the main server 150 may be arranged in logical collections of related information on a plurality of computer systems having associated non-volatile memories. The software and data may be stored using any data structures known in the art including files, arrays, linked lists, relational database tables and the like.

The server 150 and user interface devices 120 are programmed to perform the methods described herein. For example, the server is programmed with a video software module for uploading a first video and voice recording by a first user, storing the video and voice recording in the database along with a title, user name, and hashtag to identify the video and voice recording, for uploading a second video and voice recording by a second user in reply to the first video and voice recording, along with a title, user name, and hashtag, for displaying the first and second video and voice recordings, and for notifying the first use that the second video and voice recording was posted in response to the first video and voice recording; and a registration software module for registering users personal information including name, location, and friends and storing the personal information in the database.

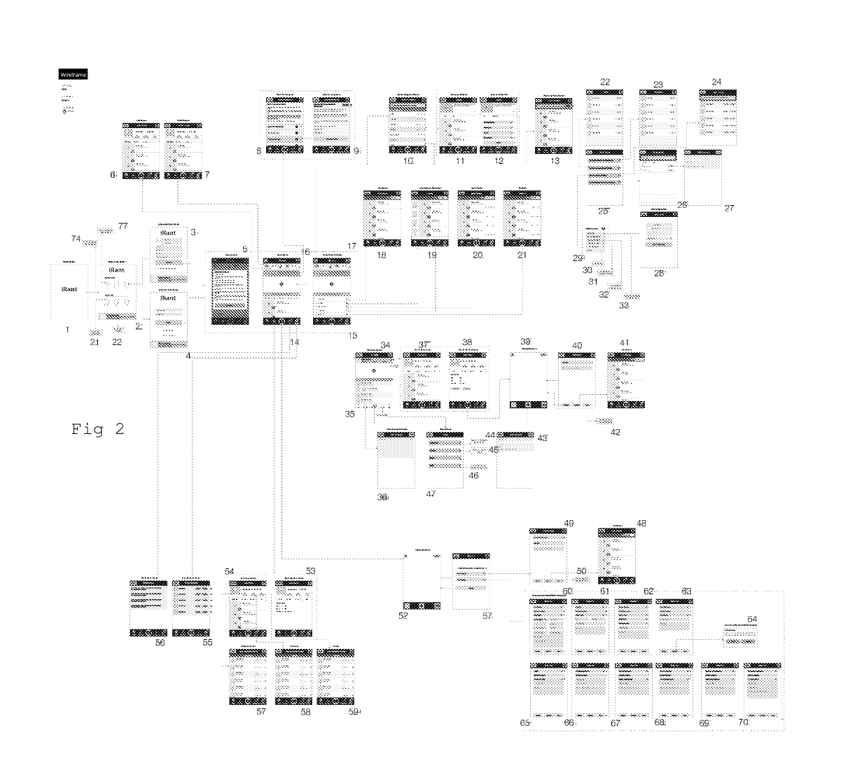

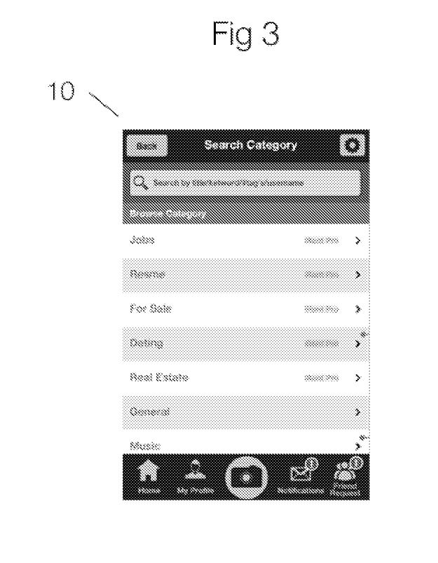

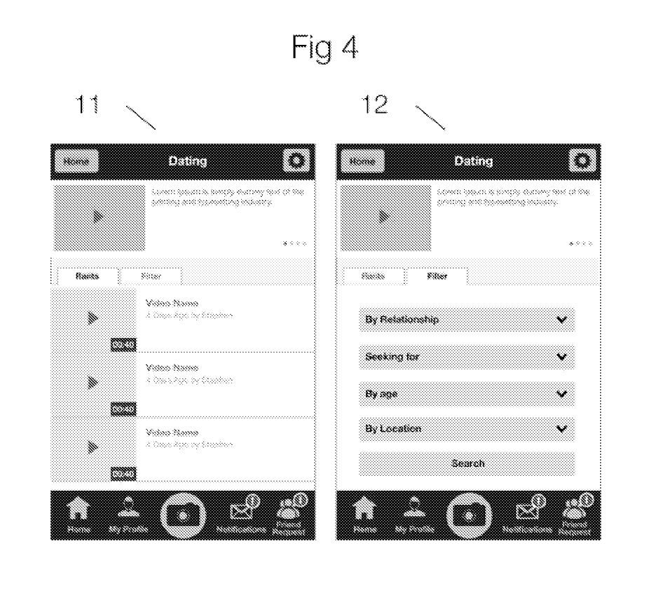

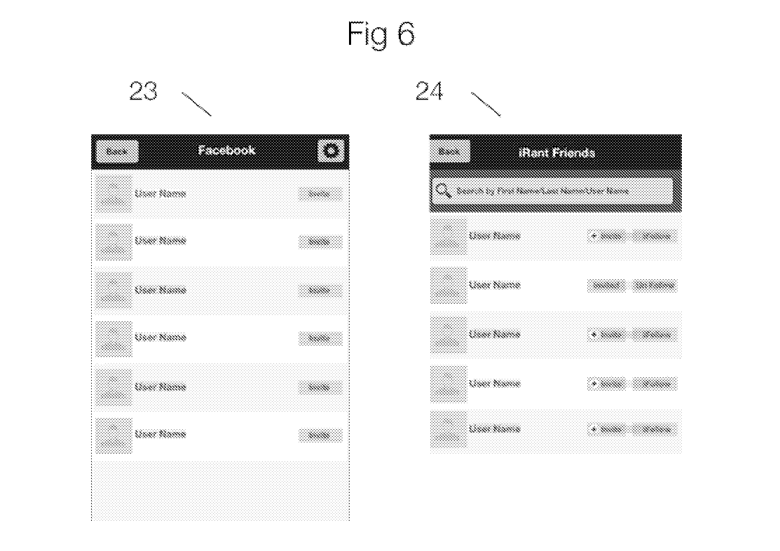

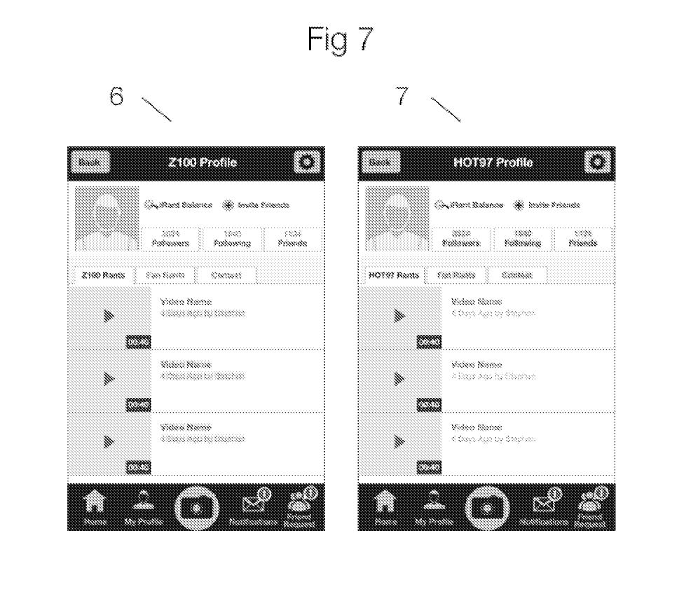

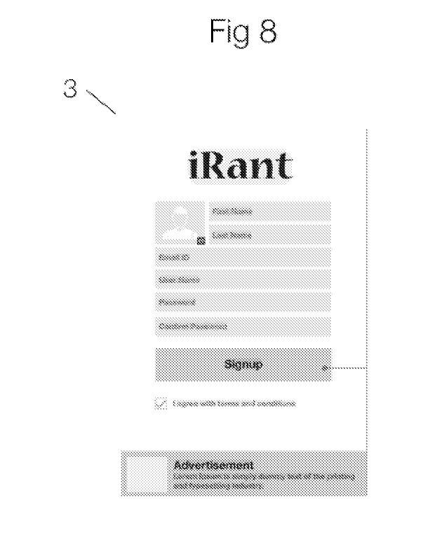

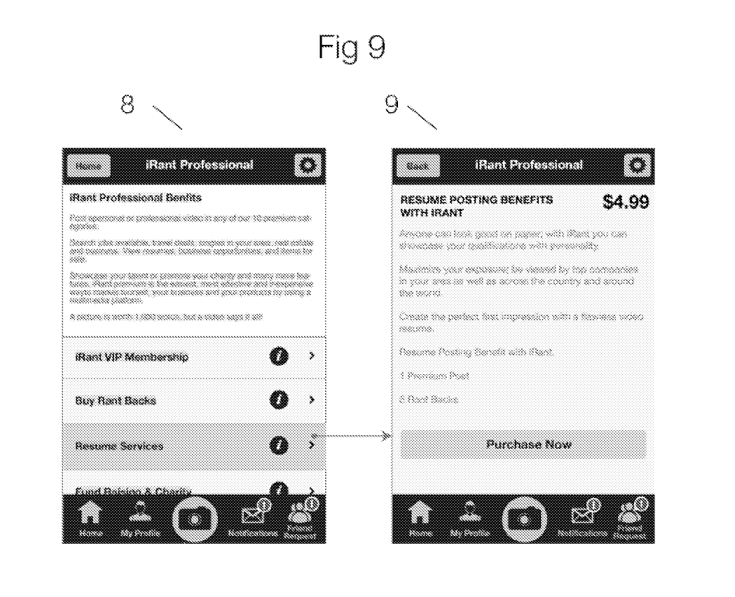

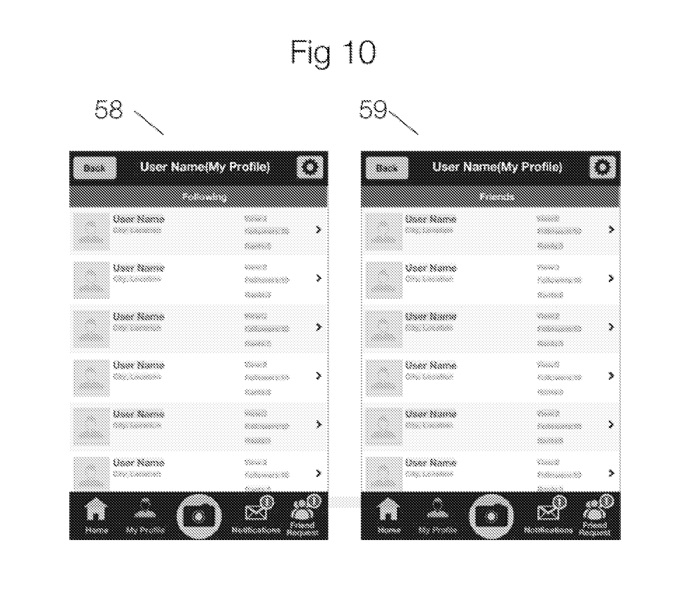

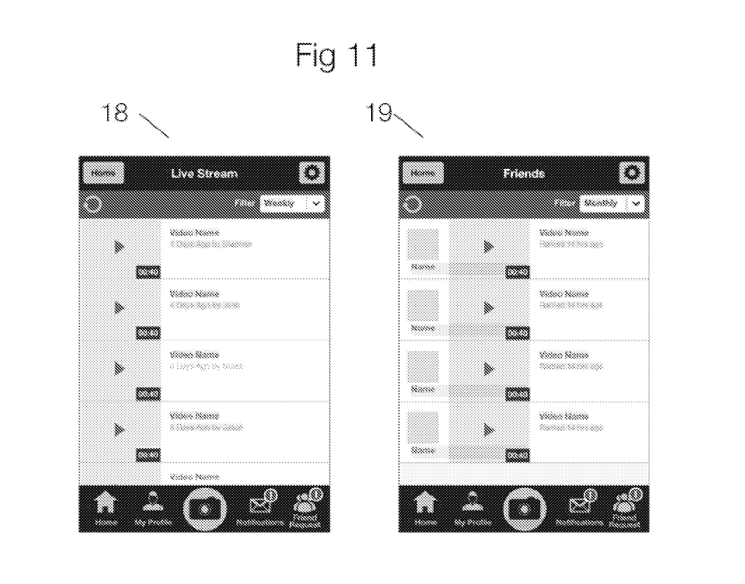

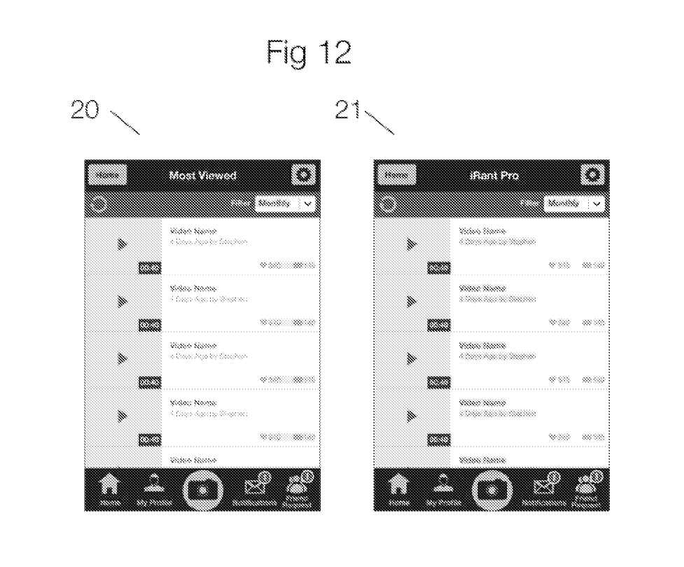

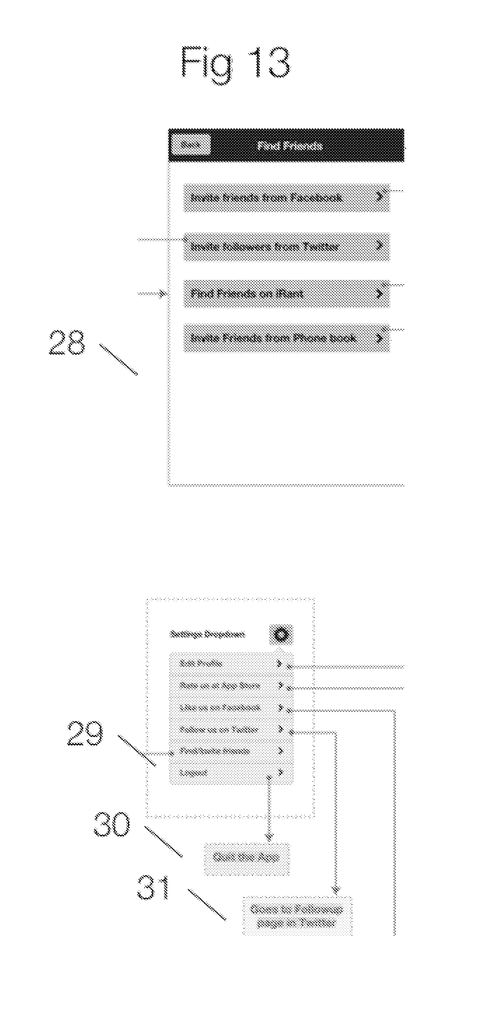

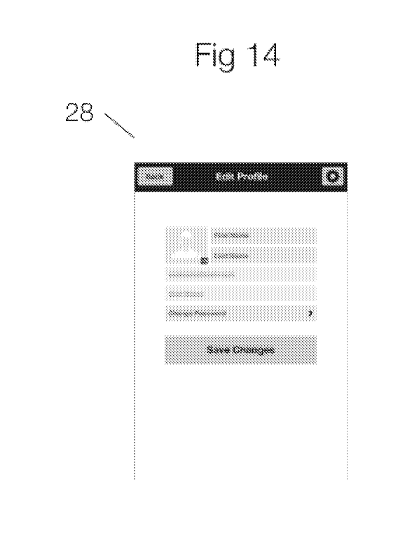

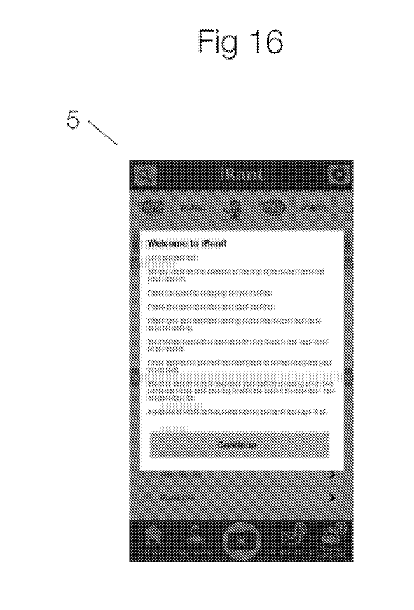

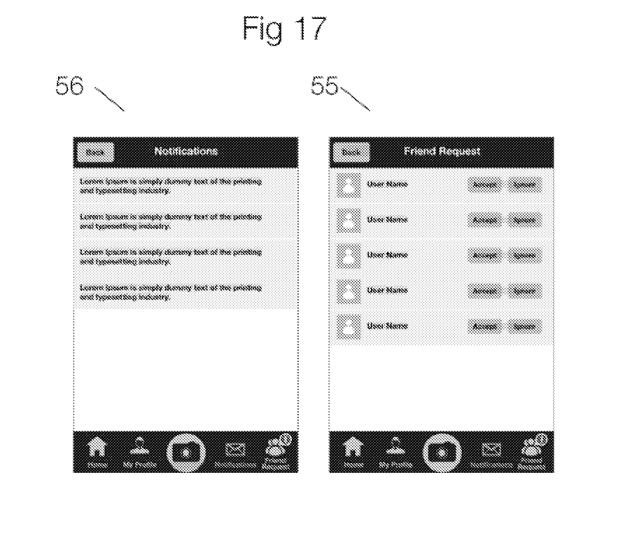

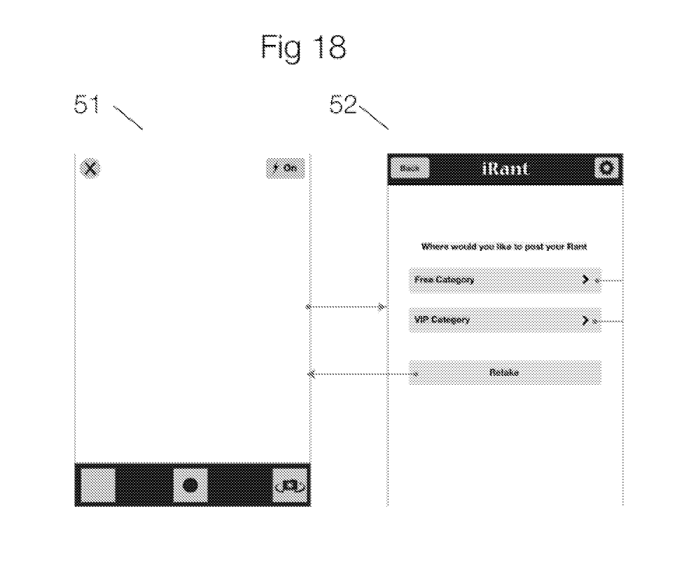

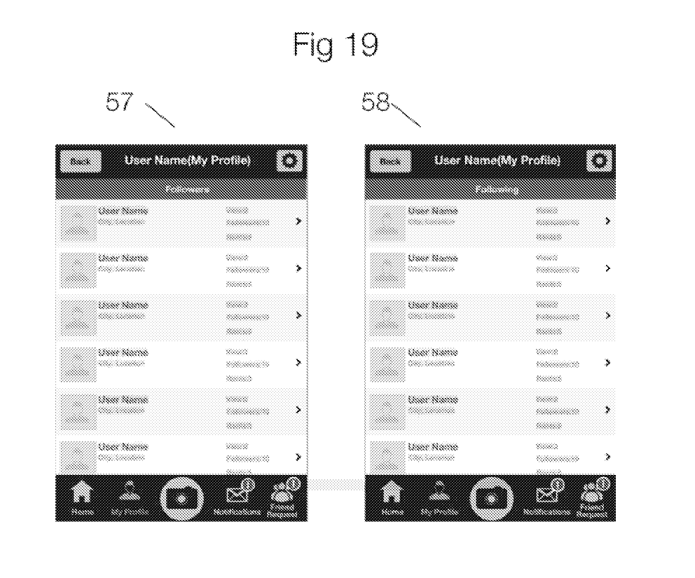

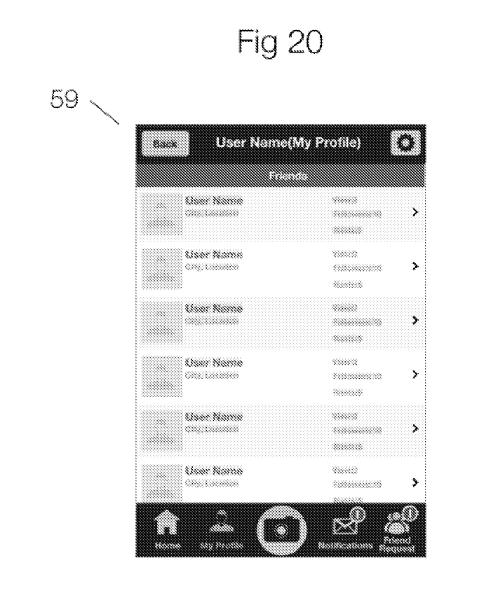

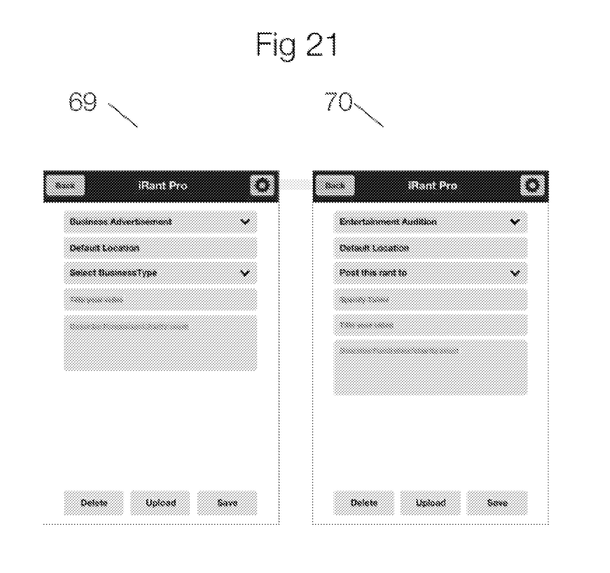

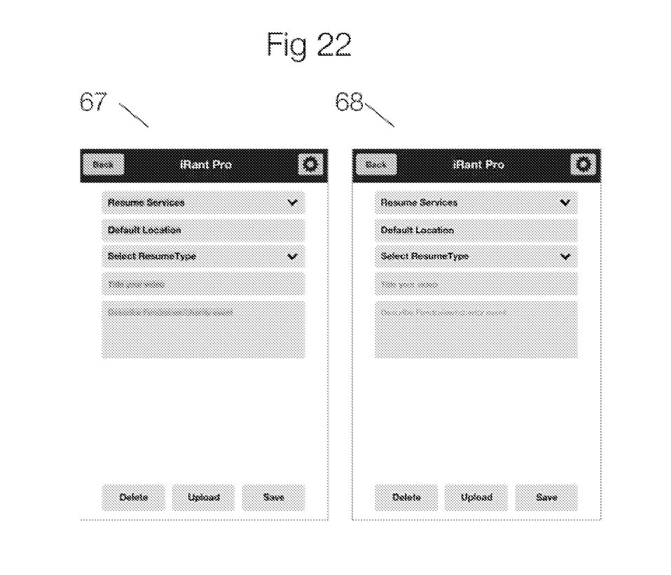

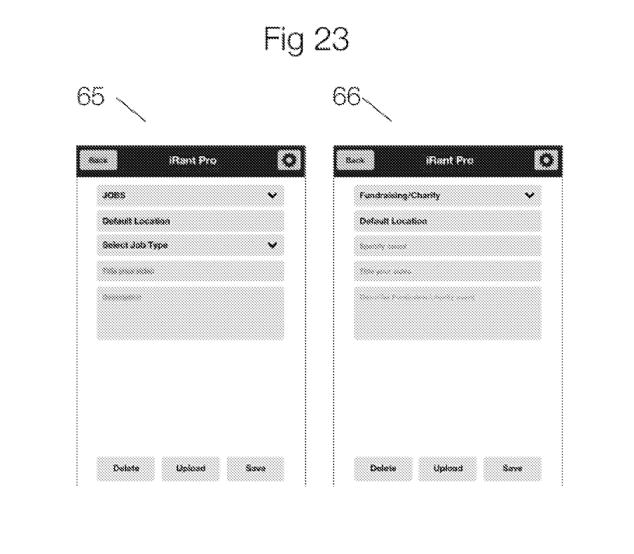

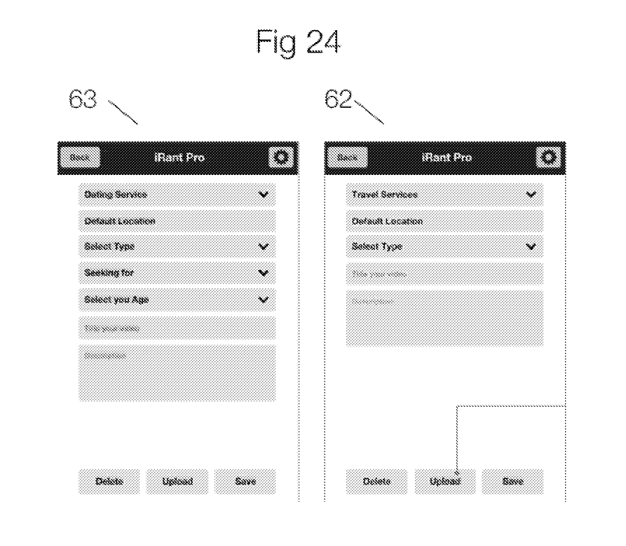

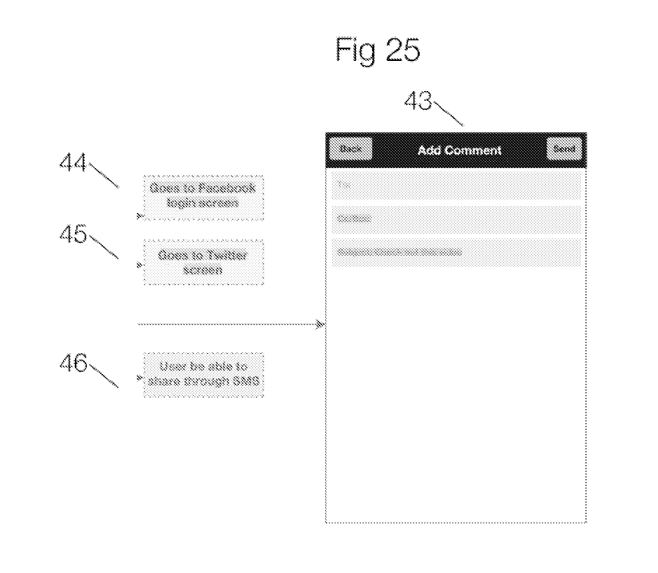

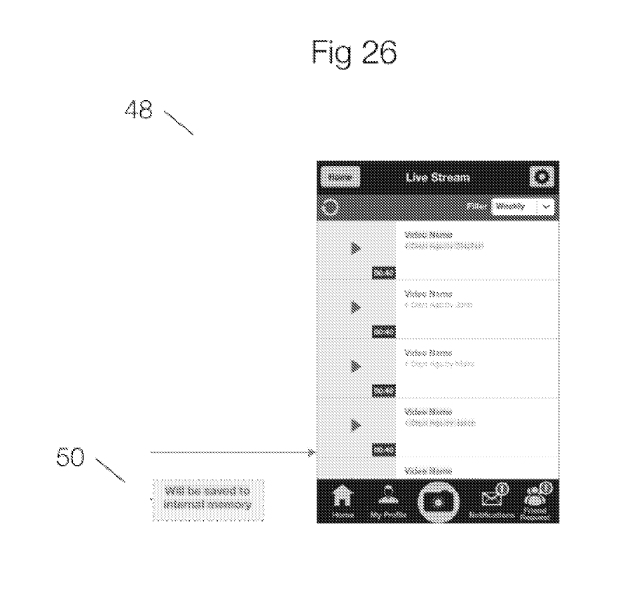

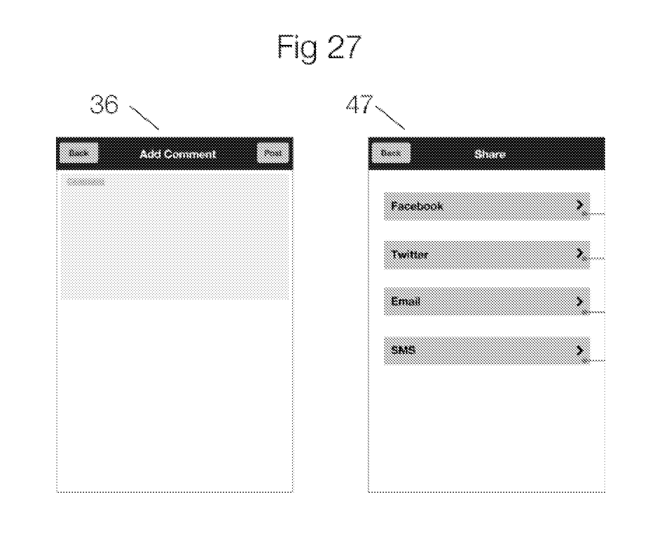

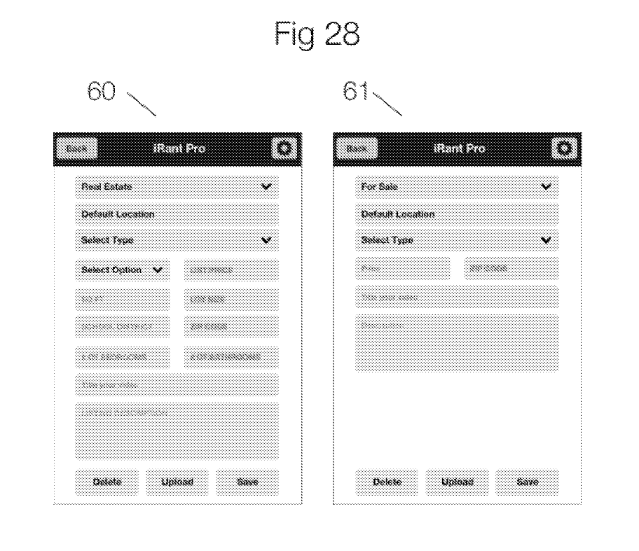

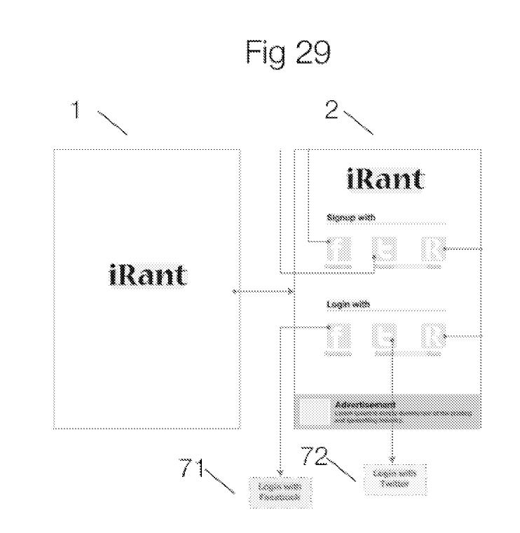

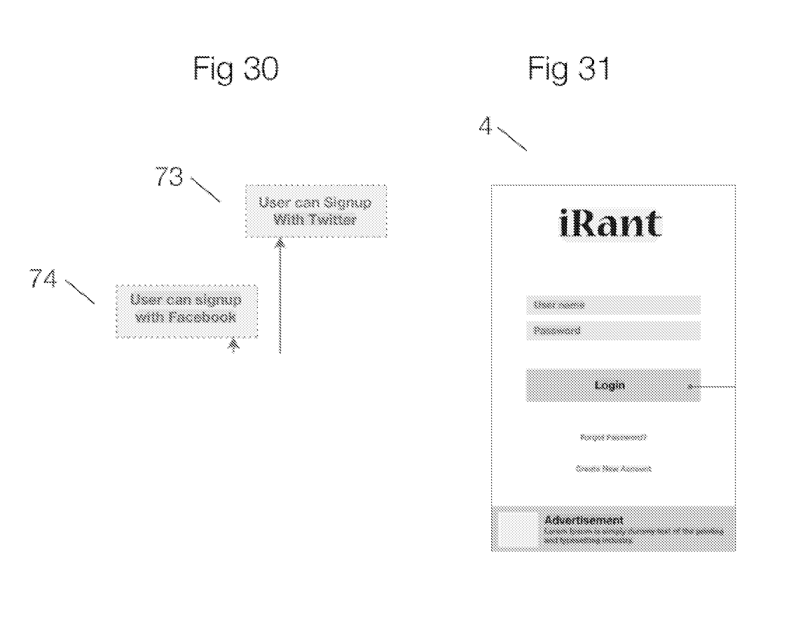

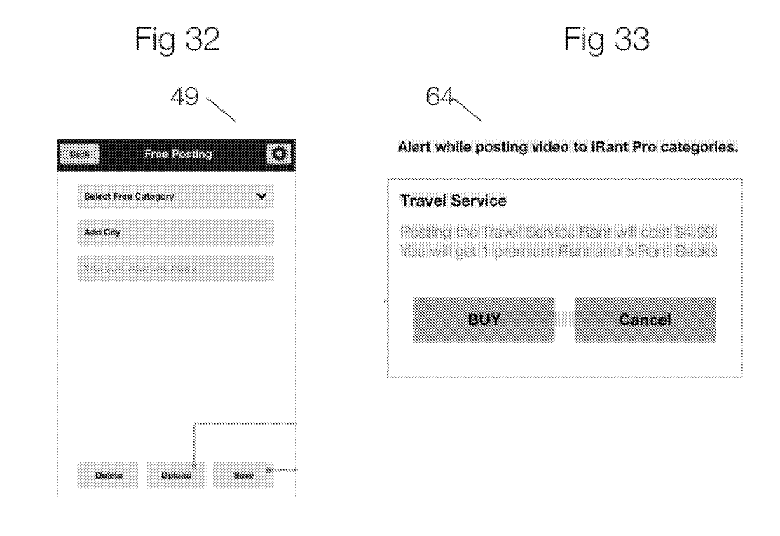

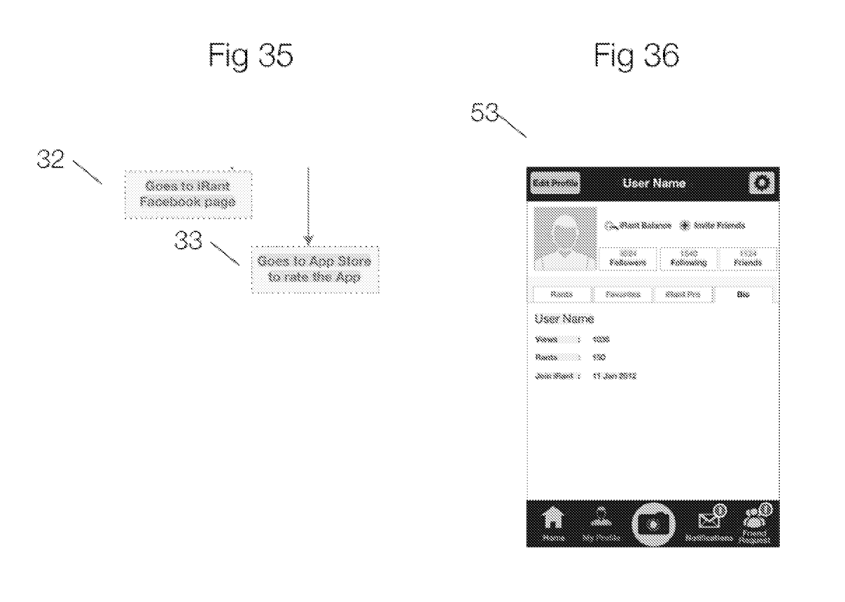

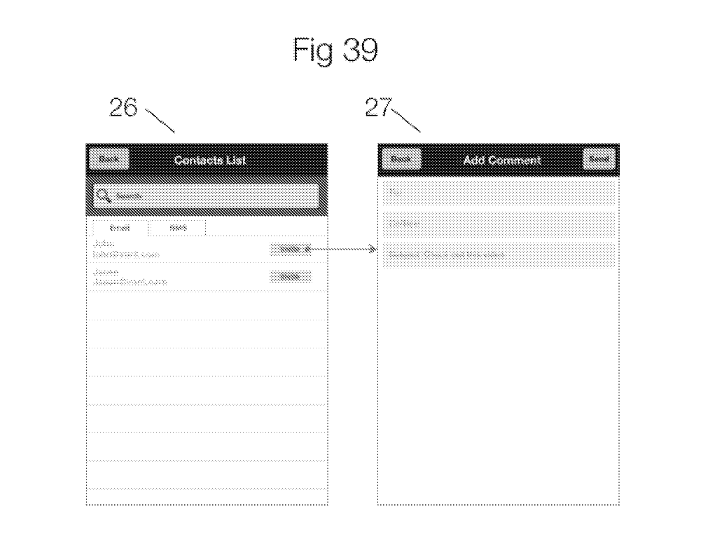

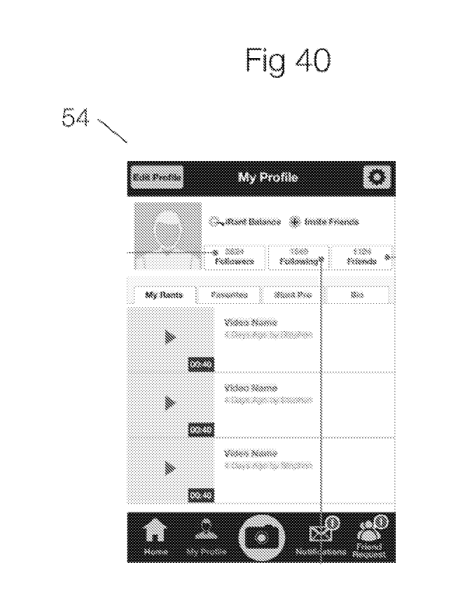

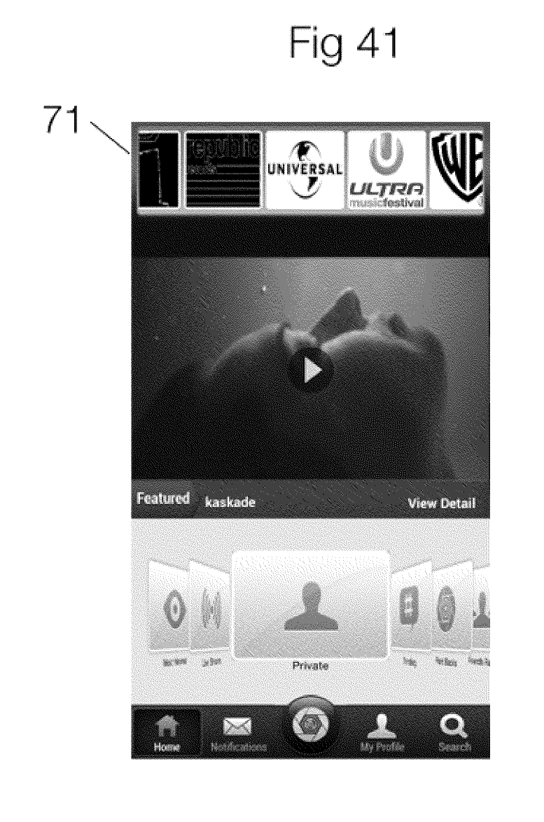

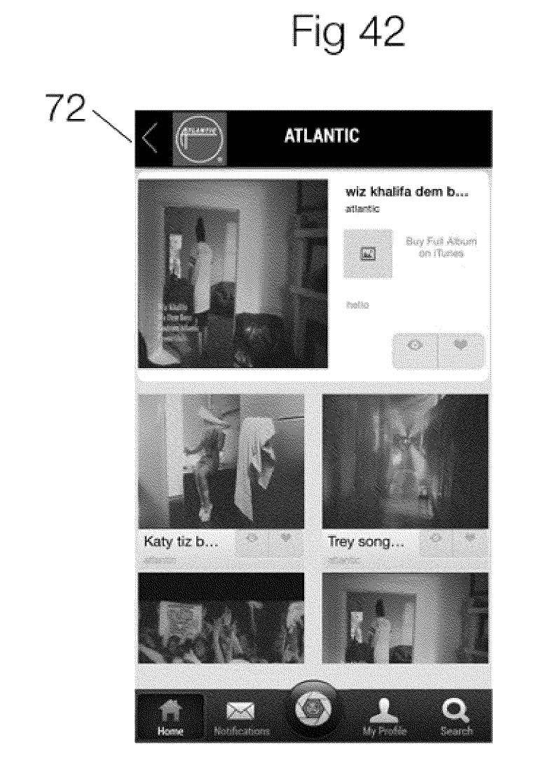

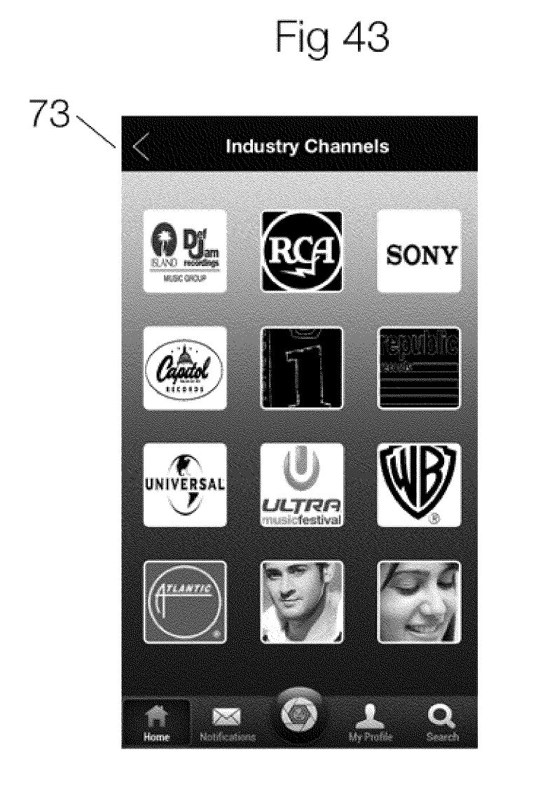

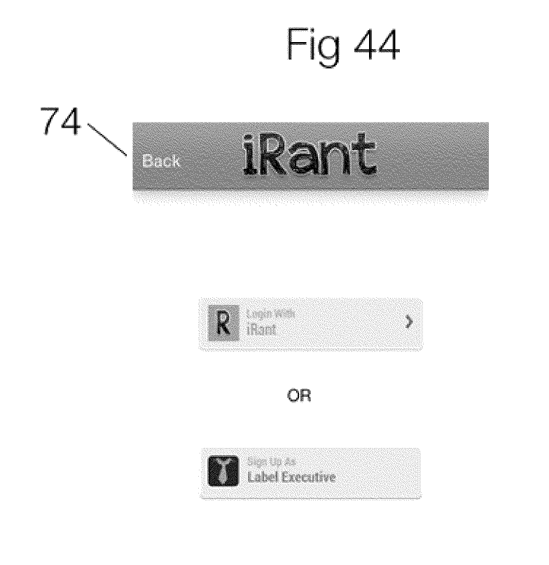

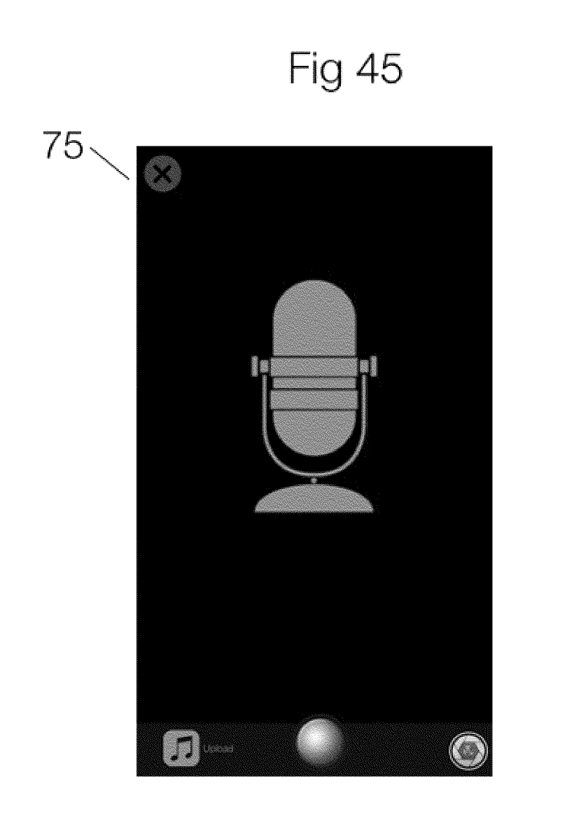

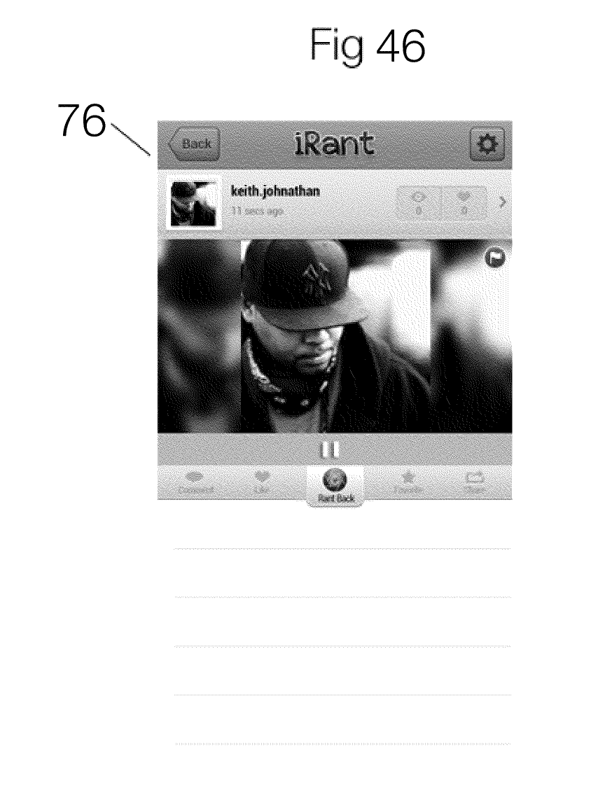

A working example of the invention is disclosed at www.irantnow.com, the complete disclosure of which is incorporated herein by reference. The attached FIGS. 2-45 are screen shots of the www.irantnow.com example. A “rant” or “rant back” is a video reply to a posted video. The posted video can be a previous video reply.

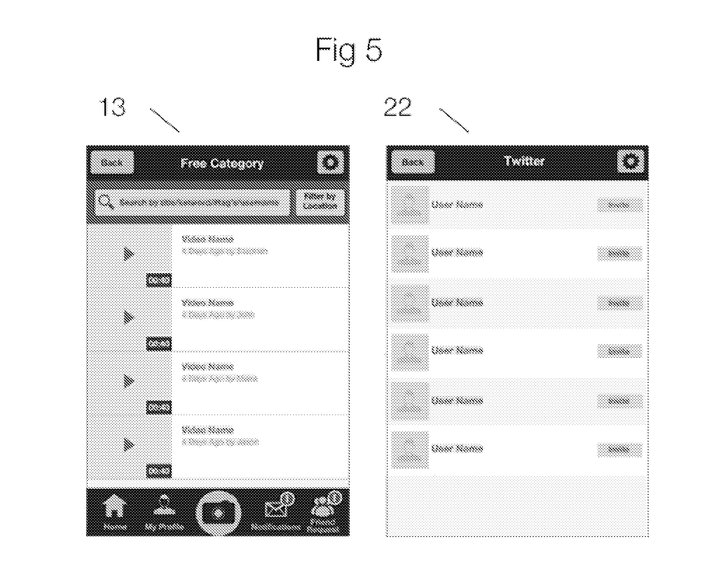

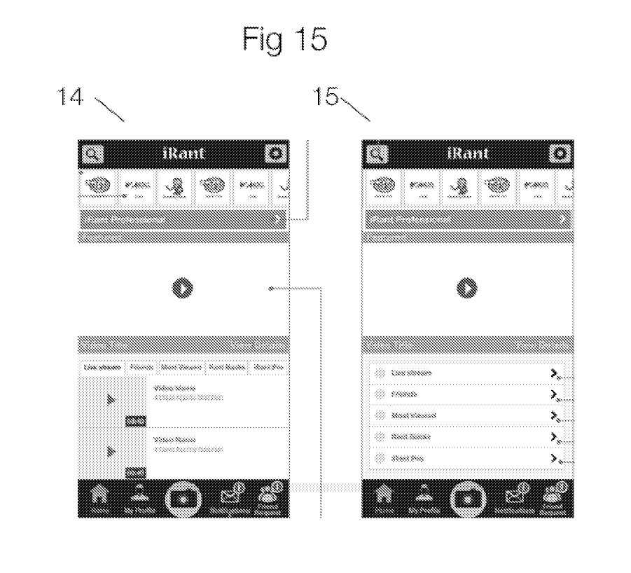

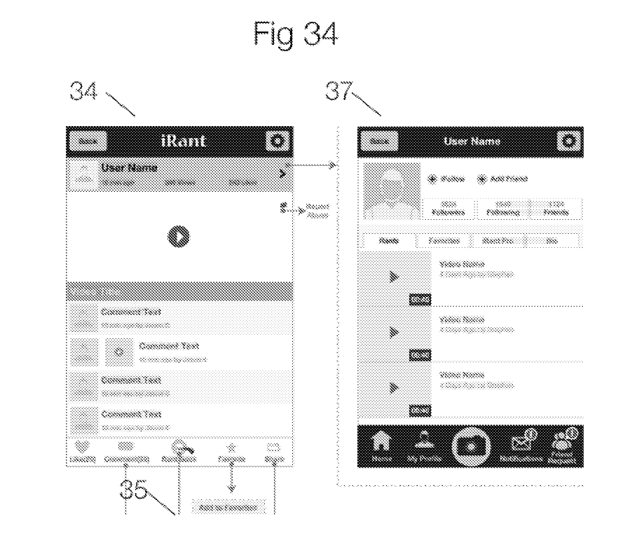

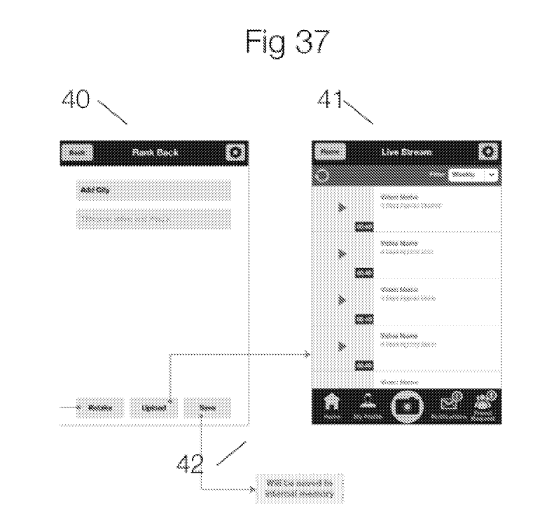

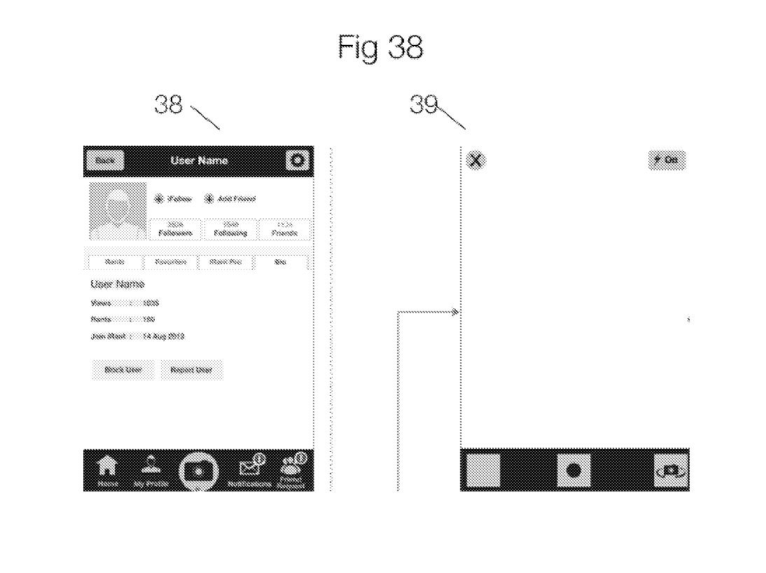

A user logs onto the website www.irantnow.com or mobile application and the screen shown in FIG. 5 is displayed. This FIG. 15 displays streaming featured videos, a swipe video category menu and upper and lower tool bar. The upper toll bar is used for searching trending videos and a tab to the settings menu page. The lower tool bar will allow users to navigate to their notifications, profile, pro categories and back home but, the main function is to bring users to the record a video screen where the user can record a video (FIG. 38) and post it so other users can immediately see it (FIG. 37) and video reply back by using the rant back feature that is available on every video landing screen (FIG. 34). The video posting and video replies are continuous and infinite. Each video whether a rant or rant back (a video or video reply) can be replied to and so on.

The initial screen has tabs for live stream, friends, most viewed, rant backs and irant professional. Usually, the video recording and replies are up to 5 minutes of video, or preferably up to 3 minutes of video.

There are multiple embodiments of the invention, such as iRant Flirt, iRant Recruiter, and iRant Marketplace for buyers and sellers.

Users are notified when friends rant back.

With sharing option via Facebook, Twitter, Youtube, SMS, Email or other, community via the iRant append video reply is fun and easy.

When a video is posted, the video can by identified by a title, the author's name and a hashtag. A hashtag is a word or an unspaced phrase prefixed with the hash symbol (“#”), i.e. a form of metadata tag.

The user name, block user, and report user can be entered.

Friend rants can show video name, when ranted, length, and picture of friend that posted the rant.

iRant Pro is an upgraded version.

The Friend Rants screen can display a picture of friend, length of rant, when posted, number of likes, and number of comments. Most viewed can also be displayed.

The My Profile screen can display tabs for invite friend, and display favorites, bio, followers, and following number of friends.

Followers, name, location, followers, number of rants, and number of views can be displayed.

The Live Stream screen can display a picture of friend, length of rant, when posted, number of likes, and number of comments.

The Friend Request screen can include tabs for accept or ignore and display the user name and location. There can be a find friends or other social media tabs. Friends can be found on twitter by name, location, with tabs being displayed for invite.

The Friends on the iRant screen can display name, location, and tabs for invite and unfollow.

The contact list screen can display user name, email, invite, and SMS.

The Upload Rant screen can display add city, title, #tag's, and video.

Industry channels or industry accounts can be included in the system and method. Industry channels can include. A user can upload an entertainment audition video or audio track to any one or multiple industry channels for review. A monetary charge can be added as desired. Video replies are as described herein. When audio tracks are uploaded, audio or video replies can be made. The audition or audio track can be uploaded to music producers, movie producers, or video producers.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

I claim:

1. A video reply or video texting method comprising:
making a first video and voice recording by a first user by a first user interface device having a video and audio recorder;
posting the first video to a website, along with an associated title and tag;
making a second video and voice in reply to the first video by a second user by a second user interface device having a video and audio recorder; and
posting the second video to the website, along with an associated title and tag.

2. The method according to claim 1, further comprising posting the first and second videos to the website along with associated hashtags.

3. The method according to claim 1, wherein the posting of the first and second videos is conducted in the absence of texting.

4. The method according to claim 1, further comprising making a third video and voice in reply to the second video by the first user by the first user interface device; and
posting the third video to the website, along with an associated title and tag.

5. The method according to claim 1, further comprising making a third video and voice in reply to the second video by a third user by a third user interface device having a video and audio recorder; and
posting the third video to the website, along with an associated title and tag.

6. The method according to claim 1, further comprising notifying the first user when the second user posts a video reply.

7. The method according to claim 1, wherein the first video is an audition and the second video is a review of the audition.

8. The method according to claim 1, wherein the firs video includes an audio track audition and the second video is a review of the audition.

9. A video reply system comprising:
a cloud-based server connected to a network, the cloud-based server being in communication with or comprising at least one non-volatile memory, a database stored in the non-volatile memory, the database comprising video and voice recordings and video and voice reply recordings;
a first user interface device configured to make a video and voice recording, the first user interface being connected to the internet and in communication with the cloud-based server;
a second user interface device configured to make a video and voice recording, the second user interface being connected to the internet and in communication with the cloud-based server;
a video software module for uploading a first video and voice recording by a first user, storing the video and voice recording in the database along with a title, user name, and hashtag to identify the video and voice recording, for uploading a second video and voice recording by a second user in reply to the first video and voice recording, along with a title, user name, and hashtag, for displaying the first and second video and voice recordings, and for notifying the first use that the second video and voice recording was posted in response to the first video and voice recording; and
a registration software module for registering users personal information including name, location, and friends and storing the personal information in the database.

10. The system according to claim 9, wherein the registration software module is configured to store the user's social groups.

11. A computer readable medium storing instructions in a non-volatile memory executable by a computing system memory including at least one cloud-based server and at least two user interface devices, wherein execution in the instructions implements a method according to claim 1.
